(19) United States
(12) Patent Application Publication
(10) Pub. No.: US 2016/0193609 A1
(43) Pub. Date: Jul. 7, 2016

(54) REFINER AND PROCESS FOR GRINDING AND HOMOGENIZING MATERIALS CONTAINING PARTICLES

(71) Applicant: ROYAL DUYVIS WIENER B.V., Koog aan de Zaan (NL)

(72) Inventor: Bartholomeus Jan ELLERMEIJER, Zwolle (NL)

(21) Appl. No.: 14/911,633

(22) PCT Filed: Aug. 13, 2014
(86) PCT No.: PCT/EP2014/067358

§ 371 Date: Feb. 11, 2016

(30) Foreign Application Priority Data
Aug. 13, 2013 (EP) 13180234.0

(51) Int. Cl. B02C 4/36; B02C 25/00; B02C 4/42; A23G 1/00; A23G 1/12

(52) U.S. Cl. CPC B02C 4/36; A23G 1/0033; A23G 1/12; B02C 4/42; B02C 25/00

(57) ABSTRACT

A refiner for grinding and homogenizing materials containing particles, including chocolate, compound, cacao, paints and inks, includes a set of rollers mounted in a frame, and a motor for driving at least one of the rollers and a sensor for measuring at least one parameter indicative of the particle size distribution in the material.

### CROSS-REFERENCE TO RELATED APPLICATION

The present application is a national stage filing of International patent application Serial No. PCT/EP2014/067358, filed Aug. 13, 2014, and published as WO 2015/022374 A1 on Feb. 19, 2015, in English.

### BACKGROUND

The discussion below is merely provided for general background information and is not intended to be used as an aid in determining the scope of the claimed subject matter.

Aspects of the invention relate to a refiner for grinding and homogenizing materials containing particles, including chocolate, compound, cacao, paints and inks, comprising a set of rollers mounted in a frame, a motor for driving at least one roller, preferably with an adjustable speed. The invention further relates to a process comprising the steps of feeding a material containing particles to a set of rollers, grinding and homogenizing the material at least by means of the set of rollers, and discharging the material from the set of rollers.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background. A refiner for improved grinding and homogenizing materials containing particles includes a sensor for measuring at least one parameter indicative of particle size distribution, a processor adapted for controlling, based on the measurements, at least one of the gap(s) between the rollers, and thus the pressure(s) exerted by the rollers on the material, the rotating speed of the rollers, and the friction between the material and the surface of the rollers, to set the particle size of the particles leaving the refiner. At least one of the sensor and the processor is adapted for inline measuring of the particle size distribution. Thus, a more accurate particle size distribution can be provided.

In a further aspect, the sensor is positioned near the last roller of the set. In yet a further aspect, the sensor is adapted for measuring a spot on (the material on) a surface of a roller, in particular of the last roller. It is preferred that the spot has a diameter in a range from 10 to 40 mm, preferably in a range from 15 to 35 mm, preferably in a range from 20 to 30 mm, preferably the spot has a diameter of about 25 mm. Within these ranges, a good representation of the particle size distribution can be obtained.

The sensor and/or the processor can be adapted for measuring a spectrum of frequencies and preferably for splitting the spectrum of frequencies into different subspectra, preferably a near infrared subspectrum.

In an aspect, at least one of the sensor and the processor is adapted for converting each of the measured subspectra into a signal, wherein the shape and amplitude of the signal are indicative of the particle size distribution.

In this context, other suitable parameters indicative of particle size distribution include the number of particles, e.g. in combination with a statistical models or lab measurements, and actual particles size.

In another aspect, at least one of the sensor and the processor is adapted for inline analyzing content of a material containing particles, such as water, sugar, fat and protein content, and inline controlling, based on the inline analyzed content, the refiner.

In yet another aspect, that the processor is adapted for comparing the inline analyzed content with a recipe database of the process, determining the recipe of the material containing particles from the recipe database on basis of the inline analyzed content, and automatically setting a machine, such as the refiner, or process. Thus, e.g. after starting a machine, such as a refiner, or changing the recipe, the (new) recipe can be recognized automatically and settings of the machine/refiner adjusted automatically preferably without intervention by e.g. an operator.

In yet a further aspect, a first sensor is positioned at the center of a roller and a second sensor is positioned near an edge of the roller. With two sensors it is possible to establish whether particle size distribution is the same over at least part of the length of a roller. Both sensors measure a parameter indicative of particle size distribution and the measured parameters are compared with each other.

The present invention further relates to a process for grinding and homogenizing materials containing particles, including chocolate, compound, cacao, paints and inks, the process comprising the steps of feeding a material containing particles to a set of rollers, grinding and homogenizing the material at least by means of the set of rollers, discharging the material from the set of rollers, and the step of: measuring at least one parameter indicative of particle size distribution. The process further comprises the step of controlling, based on the measurements, at least one of the gap(s) between the rollers, and thus the pressure (s) exerted by the rollers on the material, the rotating speed of the rollers, and the friction between the material and the surface of the rollers.

In another aspect, the process comprises the steps of inline analyzing content of a material containing particles, such as water, sugar, fat and protein content, and inline controlling of the process on basis of the inline analyzed content.

In yet a further aspect, the process comprises the steps of comparing the inline analyzed content with a recipe database of the process, determining the recipe of the material containing particles from the recipe database on basis of the inline analyzed content, and adjusting the process to the determined recipe.

### BRIEF DESCRIPTION OF THE DRAWINGS

Aspects of the invention will now be explained in more detail with reference to the drawings, which schematically show a preferred embodiment.

FIG. 1 is a side view of a refiner.

FIG. 2 is a rear view of the refiner shown in FIG. 1.

FIG. 3 is a front view of the refiner shown in FIG. 1.

FIG. 4 is a cross-sectional view of the refiner shown in FIG. 1.

FIG. 5 is a detail, marked V in FIG. 4, on a larger scale.

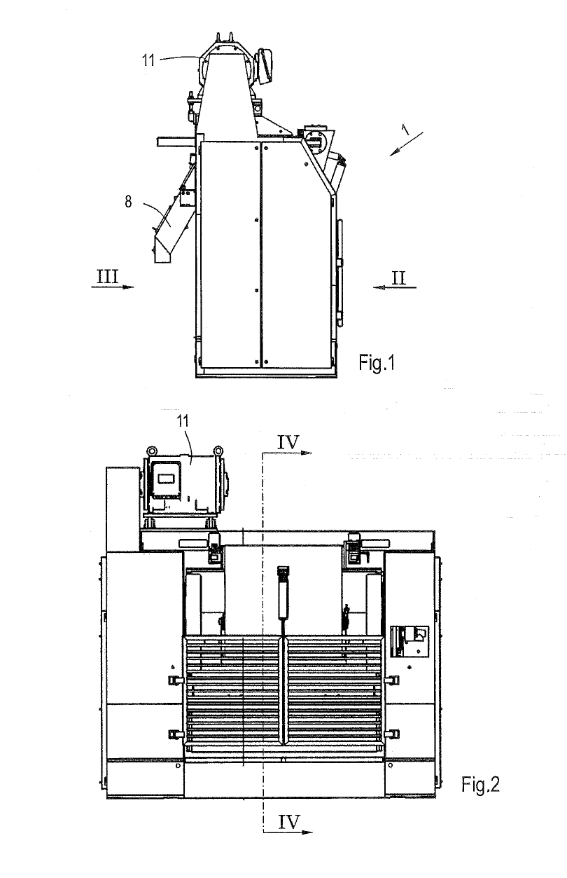

### DETAILED DESCRIPTION OF THE ILLUSTRATIVE EMBODIMENTS

A step during the process of producing for example chocolate is refining a viscous mass, e.g. containing ingredients necessary for producing chocolate. In practice, refining of the viscous mass is often done with a five roller refiner. The viscous mass is introduced into the five roller refiner 1 at an entry roller 2 of five at least substantially parallel, adjacent rollers 2-6, and subsequently the viscous mass is moved through the refiner 1 by means of the five rollers in the form of a film. The movement of the viscous mass through the refiner 1 is in the form of a serpentine moving through the gap between each pair of the successive rollers 2-6. When the viscous mass is introduced at the entry roller 2, the viscous mass forms a film on at least a part of a surface of the entry roller 2. The film of viscous mass is transferred to the successive roller after moving through a gap between the roller from which the film of viscous mass is transferred and the successive roller. The viscous mass also forms a film on the successive roller(s). When the viscous mass reaches the exit roller 6, the film of viscous mass is scraped off the exit roller 6 for example by means of a knife 7. Other ways of scraping the viscous mass from the exit roller 6 are known. After leaving the refiner 1, the viscous mass is moved for example to a conche by means of a transporting device 8.

The refiner 1 serves to refine the viscous mass e.g. to control the size of the particles in the viscous mass. When the viscous mass is intended for producing chocolate, the size of the particles in the viscous mass is important, for example for the flavor of the chocolate. It is therefore advantageous to be able to control the particle size, preferably online.

In the shown embodiment, the refiner 1 is provided with one motor 11 for driving the rollers 2-6 with an adjustable speed. It is, however, possible that two or more of rollers, e.g. each of the rollers, are provided with a motor.

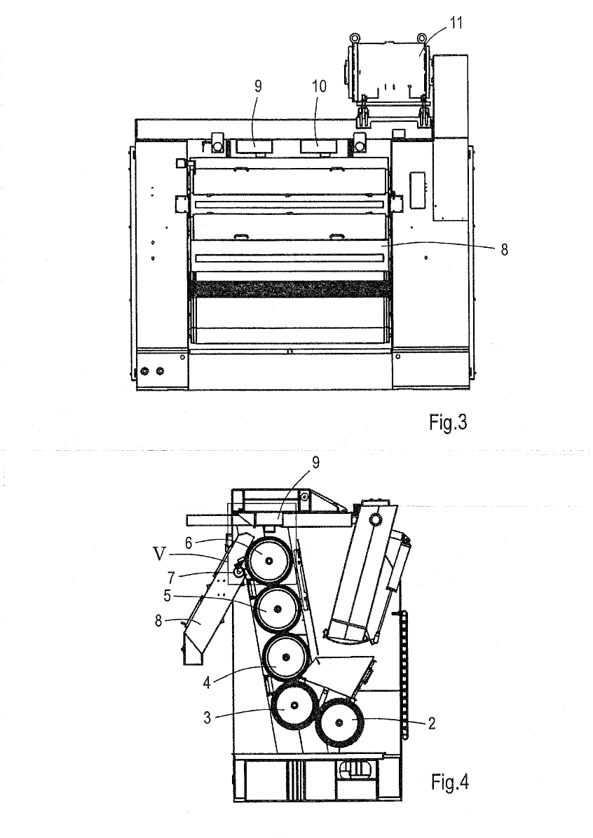

As shown in FIGS. 3 to 5, the refiner 1 is provided with a sensor 9 for measuring at least one parameter indicative of particle size distribution, and a processor adapted for controlling, based on the measurements, at least one of the gap(s) between the rollers, the rotating speed of the rollers and the friction between the material and the surface of the rollers.

The pressures exerted by the rollers 2-6 on the material are set by adjusting the gap between each pair of the successive rollers 2-6, which gap between each pair of the rollers 2-6 may be adjusted by means of mechanical means, such as hydraulic or pneumatic cylinders, electrical means, such as a stepper motor, or a combination thereof. It is preferred that the processor is adapted for adjusting the gap between two adjacent rollers in order to reduce or to increase the pressure exerted on the material in the refiner 1.

The particle size of the particles in the material may also be controlled by the rotating speed of the rollers 2-6 or the friction between the mass and the surface of the rollers 2-6. It is noted that the refiner 1 may comprise e.g. two, three or five rollers. The sensor 9 is placed near the exit roller 6 of the refiner 1. In this embodiment, the sensor 9 is positioned above the exit roller 6 of the refiner. By providing the sensor near the exit roller 6 and measuring the particle size distribution on a surface of the exit roller 6 where the film of viscous mass is still present, it is possible to measure the particle size distribution in the product inline.

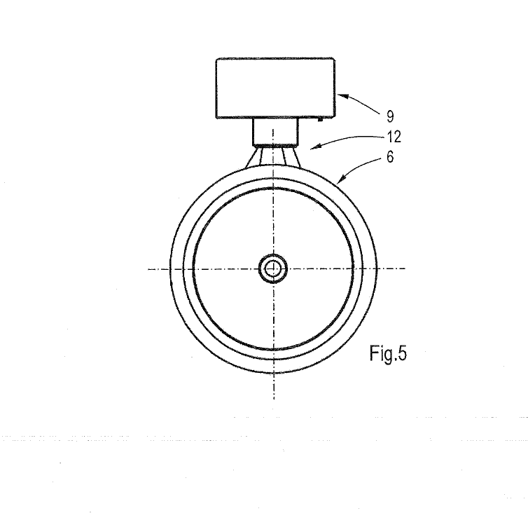

The sensor is adapted for measuring a spot 12 (FIG. 5) on a surface of a roller, which spot 12 has a diameter in a range from 10 to 40 mm, preferably in a range from 15 to 35 mm, more particularly in a range from 20 to 30 mm. In this example, the spot has a diameter of 25 mm.

The sensor and/or the processor, e.g. contained in unit 9, are adapted for measuring a spectrum of frequencies and preferably for splitting the spectrum of frequencies into different frequency areas of the near infrared spectrum. Each frequency area may be converted into a signal, wherein the shape and the amplitude of the signal are indicative of a particle size distribution.

The processor can be adapted to provide a correlation between the measurements and the desired particle size distribution. E.g., the processor can be adapted for calculating, from the measurements, particle size distribution on basis of statistical functions and/or lab analysis, e.g. correlations established via lab measurements. The sensor/processor can be calibrated accordingly, carried out to establish a correlation between the measured parameter value and the desired parameter value.

In an embodiment, a signal is generated at least every 25 milliseconds for controlling at least one of gaps between the rollers 2-6, the speed of each of the rollers 2-6 and friction on basis of the correlation between the measured parameter and the desired parameter.

In a further embodiment, the processor is adapted for inline analysing of the water, sugar, fat and/or protein content of the product and thus inline control of the refiner or other machines or processes with this application. Further, in an embodiment, the refiner is arranged to start automatically by means of the processor being adapted for comparing the inline analyzed content with a recipe database of the process, determining the recipe of the material containing particles from the recipe database on basis of the content analyzed inline, and automatically setting a machine, such as the refiner, or the process. The machine or process may be set automatically without interaction of an operator.

As can be seen in FIG. 3, it is also possible that a first sensor 9 is positioned at the center of a roller 6 and a second sensor 10 is positioned near an edge of the roller 6. With two sensors 9, 10 it is possible to ensure that the particle size distribution is at least substantially the same over the length or part of the length of the roller 6. Both sensors measure a parameter indicative of particle size distribution, the measured parameters are compared with each other. If the signals of the comparisons are substantially within the same range, two adjacent rollers are substantially parallel, ensuring that the particle size over the whole length of the roller 6 is substantially the same.

It is noted that both sensors 9, 10 may share one processor or that both sensors 9, 10 each have their own processor, which processors are connected with each other.

It is noted that the average particle size may lie in a range from 1 μm to 100 μm, preferably in a range from 1 μm to 100 μm, with an accuracy of ±1 μm.

The invention is not restricted to the above-described embodiments, which can be varied in a number of ways within the scope of the claims. For example, in addition to chocolate, the present invention can be applied also to produce compound, cacao, fat, fillings or non-food products such as paint, lacquer, ink et cetera that contain particles, e.g. pigments.

1. A refiner for grinding and homogenizing materials containing particles, including chocolate, compound, cacao, paints and inks, comprises:
a set of rollers mounted in a frame;
a motor configured to drive at least one of the rollers;
a sensor configured to measure at least one parameter indicative of the particle size distribution in the material; and
a processor configured to control, based on the measurements, at least one of the gap (s) between the rollers, the rotating speed of the rollers and the friction between the material and the surface of the rollers, wherein at least one of the sensor and the processor is configured to measure inline at least one parameter indicative of particle size distribution.

2. The refiner according to claim 1, wherein the sensor is positioned near the last roller of the set.

3. The refiner according to claim 1, wherein the sensor is configured to measure a spot on a surface of at least one the rollers.

4. The refiner according to claim 3, wherein the spot has a diameter in a range from 10 to 40 mm.

5. The refiner according to claim 1, wherein at least one of the sensor and processor is configured to measure a spectrum of frequencies.

6. The refiner according to claim 5, wherein at least one of the sensor and processor is further configured to convert each measured subspectrum into a signal, wherein the shape and amplitude of the signal are indicative of a particle size distribution.

7. The refiner according to claim 1, wherein at least one of the sensor and processor is configured to analyse inline content of a material containing particles, and/or processor is configured for inline controlling, based on an inline analysed content, the refiner.

8. The refiner according to claim 7, wherein the processor is further configured to compare the inline analysed content with a recipe database for determining the recipe of the material containing particles.

9. The refiner according to claim 1, wherein a first sensor is positioned at the center of a roller and a second sensor is positioned near an edge of the roller.

10. A process for grinding and homogenizing materials containing particles, the process comprising:
feeding a material containing particles to a set of rollers;
grinding and homogenizing the material at least by use of the set of rollers, discharging the material from the set of rollers;
measuring at least one parameter indicative of particle size distribution in the material, and controlling, based on the measurements, at least one of the gap(s) between the rollers, the rotating speed of the rollers and the friction between the material and the surface of the rollers.

11. The process according to claim 10, and further comprising inline analysing the content of a material containing particles.

12. The process according to claim 11, further comprising:
comparing the inline analysed content with a recipe database;
determining the recipe of the material on basis of the inline analysed content; and
adjusting the process to the determined recipe.

13. The process according to claim 11, and further comprising inline controlling, based on an inline analysed content, of the process.

14. The process according to claim 10, further comprising inline controlling, based on an inline analysed content, of the process.

15. The refiner of claim 5 wherein at least one of the sensor and processor is configured to measure a spectrum of frequencies for splitting the spectrum of frequencies into different subspectra.

16. The refiner of claim 5 wherein at least one of the sensor and processor is configured to measure a spectrum of frequencies for splitting the spectrum of frequencies into a near infrared subsprectrum.

17. The refiner according to claim 6, wherein at least one of the sensor and processor is configured to is configured for inline controlling, based on an inline analysed content, the refiner.

18. The refiner according to claim 1, wherein at least one of the sensor and processor is configured for inline controlling, based on an inline analysed content, the refiner.

19. The refiner according to claim 7, wherein the processor is further configured to compare the inline analysed content with a recipe database for automatically adjusting the refiner to the determined recipe.

20. The refiner according to claim 4, wherein the spot has a diameter in a range 15 to 35 mm.

21. The refiner according to claim 20, wherein the spot has a diameter in a range from 20 to 30 mm.
